(19) United States
(12) Patent Application Publication
(10) Pub. No.: US 2026/0153639 A1
(43) Pub. Date: Jun. 4, 2026

(54) MEASURE, DISPLAY, AND QUALITY CONTROL HORIZONTAL TRANSVERSE ISOTROPY IN FORMATION

(71) Applicant: Halliburton Energy Services, Inc., Houston, TX (US)

(72) Inventors: Chen Li, Houston, TX (US); Ruijia Wang, Singapore (SG); Xiang Wu, Houston, TX (US); Christopher Michael Jones, Houston, TX (US); Gennady Koscheev, Houston, TX (US)

(73) Assignee: Halliburton Energy Services, Inc., Houston, TX (US)

(21) Appl. No.: 18/964,065

(22) Filed: Nov. 29, 2024

(51) Int. Cl. G01V 1/50

(52) U.S. Cl. CPC G01V 1/50; G01V 2210/6222

(57) ABSTRACT

A method that includes disposing an acoustic logging tool in a borehole. The acoustic logging tool comprises one or more transmitters and one or more receivers. The method may further comprise taking one or more acquisitions with the acoustic logging tool as the acoustic logging tool traverses through the borehole, creating an azimuth rotation angle array of one or more angles, from the one or more acquisitions, and applying a trial angle selected from the one or more angles of the azimuth rotation angle array to calculate a fast shear waveform.

### BACKGROUND

Acoustic logging tools are employed for a variety of purposes related to formation measurement and characterization. In general, acoustic logging tools measure different dispersive acoustic waveforms, and analyze the dispersions of waveforms in order to determine various geophysical and mechanical properties of the formation through which the particular wellbore passes. More particularly, dispersions characterize the relationship between waveform slowness and waveform number/frequency may be used to provide insight into various material and geometric properties of the borehole and surrounding formation, such as profiles of rock formation shear slowness and shear slowness anisotropy around the wellbore.

### BRIEF DESCRIPTION OF THE DRAWINGS

These drawings illustrate certain aspects of some examples of the present disclosure and should not be used to limit or define the disclosure.

FIG. 1 illustrates a system comprising an acoustic logging tool;

FIG. 2 illustrates a diagrammatic view of an acoustic logging tool capable of performing the presently disclosed methods and techniques in accordance with certain exemplary embodiments of the present disclosure;

FIG. 3A-3B illustrates cross sectional views of alternate embodiments of receiver stations 1-N, according to certain illustrative embodiments of the present disclosure;

FIG. 4 illustrates is a schematic view of an information handling system;

FIG. 5 illustrates a schematic of a chip set;

FIG. 6 illustrates a computing network;

FIG. 7 illustrates an acoustic logging tool disposed within a horizontal borehole transmitting acoustic waveforms into a formation;

FIG. 8 illustrates the acoustic logging tool disposed in a vertical borehole transmitting acoustic waveforms into a formation;

FIG. 9 is a graph of crossline relative energy;

FIG. 10 illustrates a workflow for projecting acoustic waveforms to trial fast angles to minimize crossline energy in solving for fast angle values;

FIG. 11 illustrates a measurement operation in which multiple acquisitions are performed by the acoustic logging tool;

FIG. 12 is a graph corresponding to different acquisitions and different rotation angles that may be applied for the rotated acoustic signal to be pointing at the same Alford Rotated Azimuth;

FIG. 13 illustrates a graph with the location in an x coordinate representing the time delay between fast and slow;

FIG. 14 illustrates the various receiver locations and source locations for each acquisition as the logging tool moves through a subterranean formation;

FIG. 15 illustrates an acoustic waveform path for the multiple acquisitions taken in FIG. 14 to travel from one or more transmitters to one or more receivers;

FIG. 16 is a graph that horizontally stacks each rock path in which an acoustic waveform may pass from a transmitter to a receiver, as seen in FIG. 15;

FIG. 17 illustrates a workflow for varying an angle in a regularly spaced manner to allow for a relationship of inline shear velocity vs azimuth angle;

FIG. 18 is a graph plotting slowness vs. azimuth in earth coordinates;

FIG. 19 is another graph plotting slowness vs. azimuth in earth coordinates that shows inconsistent results utilizing current technology systems and methods; and

FIG. 20 graph that shows possible self-contradictory answer from current methods and systems.

### DETAILED DESCRIPTION

This disclosure details methods and systems for calculating Horizontal Transverse Isotropy (HTI). HTI calculates and models vertically fractured rocks, properties are uniform in vertical planes parallel to the fractures but vary in the direction perpendicular to the fractures and across the fractures. HTI is generally measured with wireline dipole acoustic logging tools. The dipole sources on the tool excite shear waveforms into the formation. Inside the formation, the shear waveform splits into fast and slow shear waveforms while propagating and then gets picked up by the receiver arrays on the tool. HTI anisotropy is usually measured by analyzing the cross-dipole waveforms XX, XY, YX, and YY. The formation properties of interest are the slowness value of fast shear waveform, slow shear waveform, and the azimuth information of the fast shear waveform with respect to the earth.

As discussed below, workflows may utilize waveforms from multiple acquisitions of an acoustic logging tool to improve the quality and stability of the fast azimuth measurement. Workflows project the cross-dipole waveforms from acoustic logging tool into certain angles while minimizing crossline energy. Additionally, workflows vary angles to do projection in an equally spaced manner over a circle, then perform coherence processing to obtain slowness. It should be noted that coherence processing may be performed in both time and frequency domain, thus, there may be a frequency coherence processing and time coherence processing. This way an equally spaced slowness vs angle relationship is obtained.

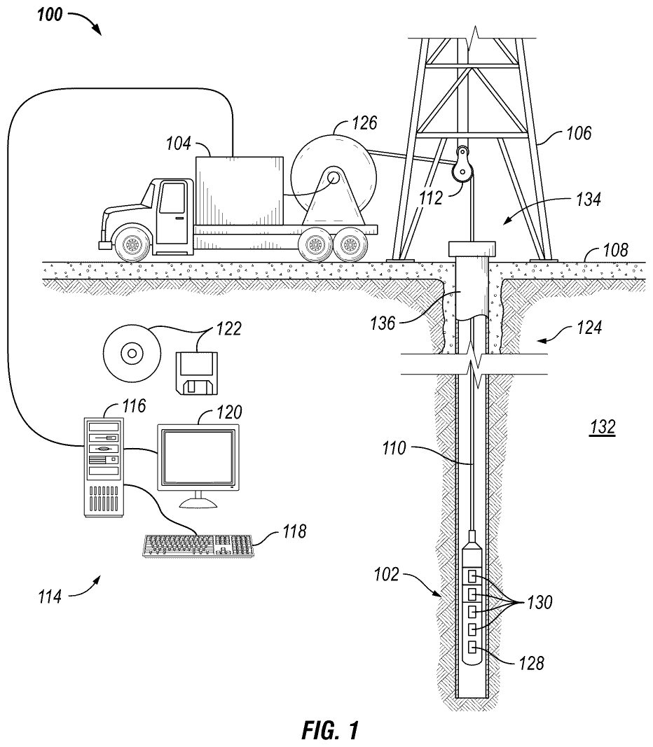

FIG. 1 illustrates a cross-sectional view of a wireline measurement operation 100. As illustrated, wireline measurement operation 100 may comprise an acoustic logging tool 102 attached to a vehicle 104. In examples, it should be noted that acoustic logging tool 102 may not be attached to a vehicle 104. Acoustic logging tool 102 may be supported by rig 106 at surface 108. Acoustic logging tool 102 may be tethered to vehicle 104 through conveyance 110. Conveyance 110 may be disposed around one or more sheave wheels 112 to vehicle 104. Conveyance 110 may comprise any suitable means for providing mechanical conveyance for acoustic logging tool 102, including, but not limited to, wireline, slickline, coiled tubing, pipe, drill pipe, downhole tractor, or the like. In some embodiments, conveyance 110 may provide mechanical suspension, as well as electrical connectivity, for acoustic logging tool 102. Conveyance 110 may comprise, in some instances, a plurality of electrical conductors extending from vehicle 104. Conveyance 110 may comprise an inner core of seven electrical conductors covered by an insulating wrap. An inner and outer steel armor sheath may be wrapped in a helix in opposite directions around the conductors. Electrical conductors may be used for communicating power and telemetry between vehicle 104 and acoustic logging tool 102. Information from acoustic logging tool 102 may be gathered and/or processed by information handling system 114. For example, signals recorded by acoustic logging tool 102 may be stored on memory and then processed by acoustic logging tool 102. The processing may be performed real-time during data acquisition or after recovery of acoustic logging tool 102. Processing may alternatively occur downhole or may occur both downhole and at surface. In some embodiments, signals recorded by acoustic logging tool 102 may be conducted to information handling system 114 by way of conveyance 110. Information handling system 114 may process the signals, and the information contained therein may be displayed for an operator to observe and stored for future processing and reference. Information handling system 114 may also contain an apparatus for supplying control signals and power to acoustic logging tool 102.

Systems and methods of the present disclosure may be implemented, at least in part, with information handling system 114. Information handling system 114 may comprise any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 114 may be a processing unit 116, a network storage device, or any other suitable device and may vary in size, shape, performance, functionality, and price. Information handling system 114 may comprise random access memory (RAM), one or more processing resources such as a central processing unit (CPU) or hardware or software control logic, ROM, and/or other types of nonvolatile memory. Additional components of the information handling system 114 may comprise one or more disk drives, one or more network ports for communication with external devices as well as various input and output (I/O) devices, such as an input device 118 (e.g., keyboard, mouse, etc.) and a video display 120. Information handling system 114 may also comprise one or more buses operable to transmit communications between the various hardware components.

Alternatively, systems and methods of the present disclosure may be implemented, at least in part, with non-transitory machine-readable media 122. Non-transitory machine-readable media 122 may comprise any instrumentality or aggregation of instrumentalities that may retain data and/or instructions for a period of time. Non-transitory machine-readable media 122 may comprise, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

As illustrated, acoustic logging tool 102 may be disposed in borehole 124 by way of conveyance 110. Borehole 124 may extend from a wellhead 134 into a subterranean formation 132 from surface 108. Generally, borehole 124 may comprise horizontal, vertical, slanted, curved, and other types of borehole geometries and orientations. Borehole 124 may be cased or uncased. In examples, borehole 124 may comprise a metallic material, such as tubular 136. By way of example, tubular 136 may be a casing, liner, tubing, or other elongated steel tubular disposed in borehole 124. As illustrated, borehole 124 may extend through subterranean formation 132. Borehole 124 may extend generally vertically into subterranean formation 132. However, borehole 124 may extend at an angle through subterranean formation 132, such as horizontal and slanted boreholes. For example, although borehole 124 is illustrated as a vertical or low inclination angle well, high inclination angle or horizontal placement of the well and equipment may be possible. It should further be noted that while borehole 124 is generally depicted as a land-based operation, those skilled in the art may recognize that the principles described herein are equally applicable to subsea operations that employ floating or sea-based platforms and rigs, without departing from the scope of the disclosure.

In examples, rig 106 comprises a load cell (not shown) which may determine the amount of pull-on conveyance 110 at surface 108 of borehole 124. While not shown, a safety valve may control the hydraulic pressure that drives drum 126 on vehicle 104 which may reel up and/or release conveyance 110 which may move acoustic logging tool 102 up and/or down borehole 124. The safety valve may be adjusted to a pressure such that drum 126 may only impart a small amount of tension to conveyance 110 over and above the tension necessary to retrieve conveyance 110 and/or acoustic logging tool 102 from borehole 124. The safety valve is typically set a few hundred pounds above the amount of desired safe pull-on conveyance 110 such that once that limit is exceeded, further pull-on conveyance 110 may be prevented.

In examples, acoustic logging tool 102 may operate with additional equipment (not illustrated) on surface 108 and/or disposed in a separate borehole acoustic logging system (not illustrated) to record measurements and/or values from subterranean formation 132. Acoustic logging tool 102 may comprise a transmitter 128. Transmitter 128 may be connected to information handling system 114, which may further control the operation of transmitter 128. Transmitter 128 may comprise any suitable transmitter for generating acoustic energy comprising at least one or more waveforms and/or sound waveforms into subterranean formation 132, including, but not limited to, piezoelectric transmitters. Transmitter 128 may be a monopole source, a multi-pole source (e.g., a dipole source, quadrupole source), high-order multipole, or any combination of multiple sources. Combinations of different types of transmitters may also be used. During operations, transmitter 128 may broadcast sound waveforms (e.g., acoustic waveforms) from acoustic logging tool 102 that travel into subterranean formation 132. The acoustic waveforms may be emitted at any suitable frequency range. It should be understood that the present technique should not be limited to these frequency ranges. Rather, the acoustic waveforms may be emitted at any suitable frequency for a particular application.

Acoustic logging tool 102 may also comprise a receiver 130. As illustrated, there may be a plurality of receivers 130 disposed on acoustic logging tool 102. Receiver 130 may comprise any suitable receiver for receiving acoustic waveforms, including, but not limited to, piezoelectric receivers. For example, receiver 130 may be a monopole receiver or multi-pole receiver (e.g., a dipole receiver), which may be multiple receivers 130 disposed in a receiver station, discussed below. Receivers 130 may be configured to measure an acoustic waveform. In examples, receiver 130 may have the function of recording dipole signals from two directions that are perpendicular to each other. Receiver 130 may also have the function of recording quadrupole signals from two directions that are 45 degrees apart. In examples, signals recorded by receiver 130 may be digitally created by information handling system 114 in any direction to simulate dipole and quadrupoles measurements. Receiver 130 may measure and/or record acoustic waveforms broadcasted from transmitter 128. The acoustic waveforms received at receiver 130 may comprise both direct waveforms that traveled along the borehole 124 and through subterranean formation 132. Acoustic waveforms may comprise, but are not limited to, compressional (P) waveforms and shear(S) waves. By way of example, acoustic waveforms may be recorded as an acoustic amplitude as a function of time. Information handling system 114 may control the operation of receiver 130. The measured acoustic waveforms may be transferred to information handling system 114 for further processing. In examples, there may be any suitable number of transmitters 128 and/or receivers 130, which may be controlled by information handling system 114. Information and/or measurements may be processed further by information handling system 114 to determine properties of borehole 124, fluids, and/or subterranean formation 132.

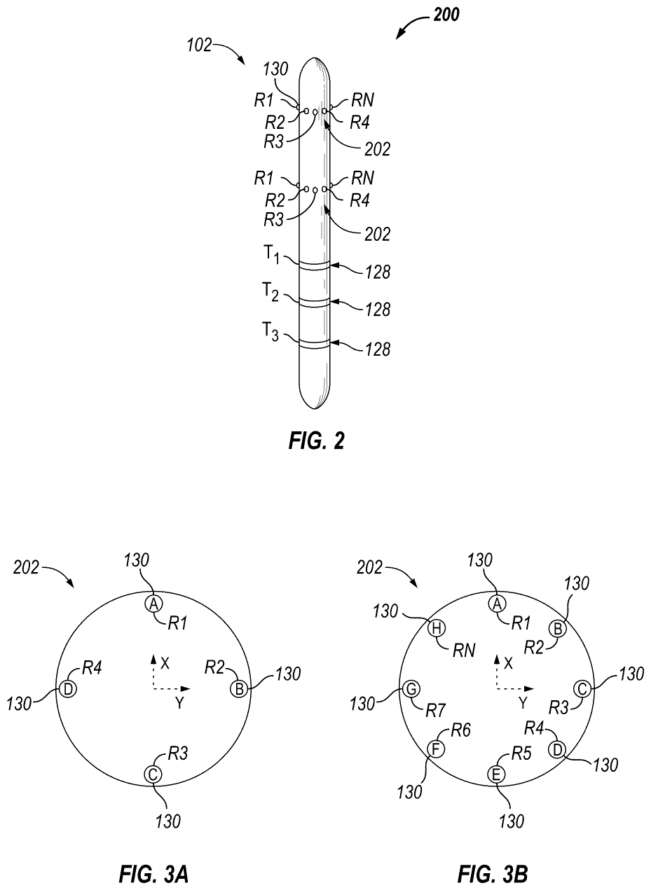

FIG. 2 illustrates a diagrammatic view of an acoustic logging tool 102 capable of performing the presently disclosed methods and techniques in accordance with certain exemplary embodiments of the present disclosure. As noted above, acoustic logging tool 102 may comprise one or more receivers 130. One or more receivers 130 may be positioned on acoustic logging tool 102 at selected distances (e.g., axial spacing) away from one or more transmitters 128. The axial spacing of receiver 130 from transmitter 128 may vary, for example, from about 0 inches (0 cm) to about 40 inches (101.6 cm) or more. In some embodiments, at least one receiver 130 may be placed nearer to the one or more transmitters 128 (e.g., within at least 1 inch (2.5 cm) while one or more additional receivers 130 may be spaced from 1 foot (30.5 cm) to about 5 feet (152 cm) or more from transmitter 128. It should be understood that the configuration of acoustic logging tool 102 shown on FIG. 2 is merely illustrative and other configurations of acoustic logging tool 102 may be used with the disclosure. In addition, acoustic logging tool 102 may comprise more than one transmitter 128 and more than one receiver 130. For example, an array of receivers 130 may be used. Transmitters 128 may comprise any suitable acoustic source for generating acoustic signals downhole, comprising, but not limited to, monopole and multipole sources (e.g., dipole, cross-dipole, quadrupole, hexapole, or higher order multi-pole transmitters). Additionally, one or more transmitters 128 (which may comprise segmented transmitters) may be combined to excite a mode corresponding to an irregular/arbitrary mode shape. Specific examples of suitable transmitters 128 may comprise, but are not limited to, piezoelectric elements, bender bars, or other transducers suitable for generating acoustic signals downhole. Receivers 130 may comprise any suitable acoustic receiver suitable for use downhole, comprising piezoelectric elements that may convert acoustic signals into an electric signal.

Acoustic logging tool 102 may be disposed on one or more sub-assemblies. In general, sub-assemblies may comprise parts or units of acoustic logging tool 102. The one or more sub-assemblies may be designed to be incorporated with other units into a larger manufactured product. Without limitation, acoustic logging tool 102 may comprise multiple sub-assemblies with various parts of an acoustic logging tool 102. In some embodiments, transmitters 128 and receivers 130 may be disposed on separate sub-assemblies to be disposed on acoustic logging tool 102. As depicted in FIG. 2, acoustic logging tool 102 comprises one or more transmitters 128. Transmitters 128 may also be identified in FIG. 2 as transmitters T1-T3. Transmitters 128 may be capable of transmitting acoustic signals/waveforms of different azimuthal orders, although additional transmitters 128 may be provided as desired to provide the same capability. Moreover, transmitters 128 may be any suitable source, such as a dipole source for example. As illustrated, one or more receivers 130 may form a receiver station 202. It should be noted that in FIG. 2, receivers 130 may also be identified as R1-RN, where each receiver 130 may be utilized to form receiver station 202. Receiver stations 202 may be further identified in FIG. 2 as receiver station 1-N to indicate that any number of receiver stations 202 may be disposed on acoustic logging tool 102. Receiver station 202, more specifically, may be a station or component of acoustic logging tool 102 and may comprise an array or assortment of receivers 130. Receivers 130 disposed on a receiver station 202 may be arranged in any arrangement or location. In certain embodiments, receivers 130 are evenly spaced along acoustic logging tool 102, and (although not shown) receivers 130 are distributed azimuthally in a plane perpendicular to the axis of acoustic logging tool 102. As illustrated, receivers R1-RN are evenly spaced, however, any selected spacing may be created between each receiver 130 and/or each receiver station 202.

FIGS. 3A & 3B is a cross-sectional view of receiver stations 202. As illustrated in FIGS. 3A & 3B, each receiver station 202 may comprise receiver(s) R1-RN evenly spaced azimuthally in the plane perpendicular to the axis of acoustic logging tool 102. Without limitation, receivers 130 may be spaced in any configuration. Receivers 130 may be disposed at the center of acoustic logging tool 102, on the outer edge of acoustic logging tool 102, or on the outside surface of acoustic logging tool 102. In embodiments, receiver station 202 illustrated in FIG. 3A comprises four receivers 130, and receiver station 202 illustrated in FIG. 3B comprises eight receivers 130, though any number of receivers 130 may be disposed in any suitable configuration. Acoustic waveforms sensed by one or more receivers 130, as discussed above, may be measured and/or recorded by information handling system 114 (e.g., referring to FIG. 1).

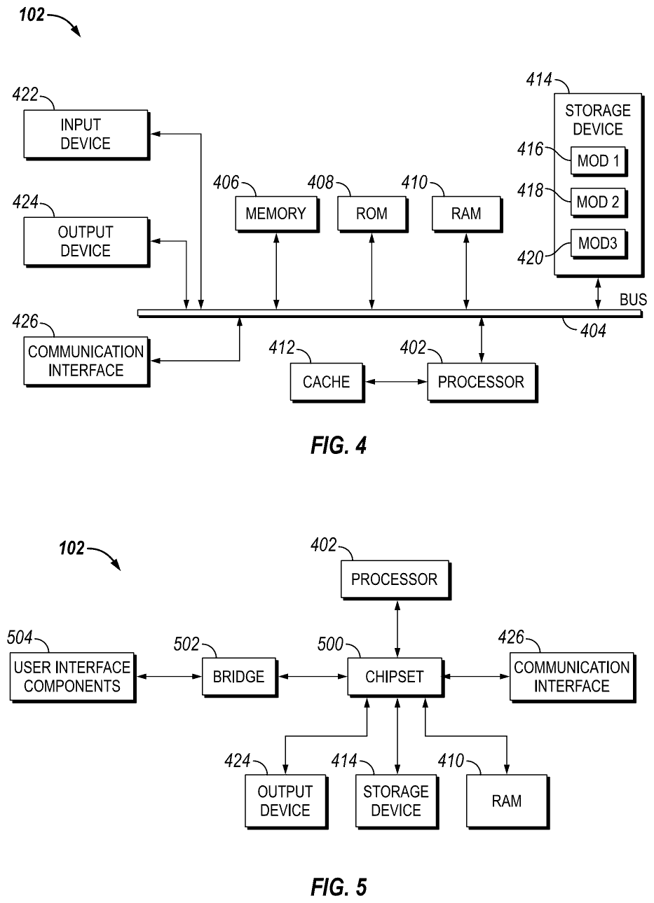

FIG. 4 further illustrates an example information handling system 114 which may be employed to perform various steps, methods, and techniques disclosed herein. Persons of ordinary skill in the art will readily appreciate that other system examples are possible. As illustrated, information handling system 114 comprises a processing unit (CPU or processor) 402 and a system bus 404 that couples various system components comprising system memory 406 such as read only memory (ROM) 408 and random-access memory (RAM) 410 to processor 402. Processors disclosed herein may all be forms of this processor 402. Information handling system 114 may comprise a cache 412 of high-speed memory connected directly with, in close proximity to, or integrated as part of processor 402. Information handling system 114 copies data from memory 406 and/or storage device 414 to cache 412 for quick access by processor 402. In this way, cache 412 provides a performance boost that avoids processor 402 delays while waiting for data. These and other modules may control or be configured to control processor 402 to perform various operations or actions. Other system memory 406 may be available for use as well. Memory 406 may comprise multiple different types of memory with different performance characteristics. It may be appreciated that the disclosure may operate on Information handling system 114 with more than one processor 402 or on a group or cluster of computing devices networked together to provide greater processing capability. Processor 402 may comprise any general-purpose processor and a hardware module or software module, such as first module 416, second module 418, and third module 420 stored in storage device 414, configured to control processor 402 as well as a special-purpose processor where software instructions are incorporated into processor 402. Processor 402 may be a self-contained computing system, containing multiple cores or processors, a bus, memory controller, cache, etc. A multi-core processor may be symmetric or asymmetric. Processor 402 may comprise multiple processors, such as a system having multiple, physically separate processors in different sockets, or a system having multiple processor cores on a single physical chip. Similarly, processor 402 may comprise multiple distributed processors located in multiple separate computing devices but working together such as via a communications network. Multiple processors or processor cores may share resources such as memory 406 or cache 412 or may operate using independent resources. Processor 402 may comprise one or more state machines, an application specific integrated circuit (ASIC), or a programmable gate array (PGA) comprising a field PGA (FPGA).

Each individual component discussed above may be coupled to system bus 404, which may connect each and every individual component to each other. System bus 404 may be any of several types of bus structures comprising a memory bus or memory controller, a peripheral bus, and a local bus using any of a variety of bus architectures. A basic input/output (BIOS) stored in ROM 408 or the like, may provide the basic routine that helps to transfer information between elements within Information handling system 114, such as during start-up. Information handling system 114 further comprises storage devices 414 or machine-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 414 may comprise software modules 416, 418, and 420 for controlling processor 402. Information handling system 114 may comprise other hardware or software modules. Storage device 414 is connected to the system bus 404 by a drive interface. The drives and the associated machine-readable storage devices provide nonvolatile storage of machine-readable instructions, data structures, program modules and other data for Information handling system 114. In one aspect, a hardware module that performs a particular function comprises the software component stored in a tangible machine-readable storage device in connection with hardware components, such as processor 402, system bus 404, and so forth, to carry out a particular function. In another aspect, the system may use a processor and machine-readable storage device to store instructions which, when executed by the processor, cause the processor to perform operations, a method or other specific actions. The basic components and appropriate variations may be modified depending on the type of device, such as whether Information handling system 114 is a small, handheld computing device, a desktop machine, or a machine server. When processor 402 executes instructions to perform “operations”, processor 402 may perform the operations directly and/or facilitate, direct, or cooperate with another device or component to perform the operations.

As illustrated, Information handling system 114 employs storage device 414, which may be a hard disk or other types of machine-readable storage devices which may store data that are accessible by a machine, such as magnetic cassettes, flash memory cards, digital versatile disks (DVDs), cartridges, random access memories (RAMs) 410, read only memory (ROM) 408, a cable containing a bit stream and the like, may also be used in the exemplary operating environment. Tangible machine-readable storage media, machine-readable storage devices, or machine-readable memory devices, expressly exclude media such as transitory waves, energy, carrier signals, electromagnetic waves, and signals per se.

To enable user interaction with Information handling system 114, an input device 422 represents any number of input mechanisms, such as a microphone for speech, a touch-sensitive screen for gesture or graphical input, keyboard, mouse, motion input, speech and so forth. Additionally, input device 422 may receive one or more measurements from acoustic logging tool 102 (e.g., referring to FIG. 1), discussed above. An output device 424 may also be one or more of a number of output mechanisms known to those of skill in the art. In some instances, multimodal systems enable a user to provide multiple types of input to communicate with Information handling system 114. Communications interface 426 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, comprising, but not limited to, hardware capable of executing software and hardware, such as a processor 402, that is purpose-built to operate as an equivalent to software executing on a general-purpose processor. For example, the functions of one or more processors presented in FIG. 5 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) 408 for storing software performing the operations described below, and random-access memory (RAM) 410 for storing results. Very large-scale integration (VLSI) hardware embodiments, as well as custom VLSI circuitry in combination with a general-purpose DSP circuit, may also be provided.

FIG. 5 illustrates an example information handling system 114 having a chipset architecture that may be used in executing the described method and generating and displaying a graphical user interface (GUI). Information handling system 114 is an example of machine hardware, software, and firmware that may be used to implement the disclosed technology. Information handling system 114 may comprise a processor 402, representative of any number of physically and/or logically distinct resources capable of executing software, firmware, and hardware configured to perform identified computations. Processor 402 may communicate with a chipset 500 that may control input to and output from processor 402. In this example, chipset 500 outputs information to output device 424, such as a display, and may read and write information to storage device 414, which may comprise, for example, magnetic media, and solid-state media. Chipset 500 may also read data from and write data to RAM 410. A bridge 502 for interfacing with a variety of user interface components 504 may be provided for interfacing with chipset 500. User interface components 504 may comprise a keyboard, a microphone, touch detection and processing circuitry, a pointing device, such as a mouse, and so on. In general, inputs to Information handling system 114 may come from any of a variety of sources, machine generated and/or human generated.

Chipset 500 may also interface with one or more communication interfaces 426 that may have different physical interfaces. Such communication interfaces may comprise interfaces for wired and wireless local area networks, for broadband wireless networks, as well as personal area networks. Some applications of the methods for generating, displaying, and using the GUI disclosed herein may comprise receiving ordered datasets over the physical interface or be generated by the machine itself by processor 402 analyzing data stored in storage device 414 or RAM 410. Further, information handling system 114 receives inputs from a user via user interface components 504 and executes appropriate functions, such as browsing functions by interpreting these inputs using processor 402.

In examples, information handling system 114 may also comprise tangible and/or non-transitory machine-readable storage devices for carrying or having machine-executable instructions or data structures stored thereon. Such tangible machine-readable storage devices may be any available device that may be accessed by a general purpose or special purpose machine, comprising the functional design of any special purpose processor as described above. By way of example, and not limitation, such tangible machine-readable devices may comprise RAM, ROM, EEPROM, CD-ROM or other optical disk storage, magnetic disk storage or other magnetic storage devices, or any other device which may be used to carry or store program code in the form of machine-executable instructions, data structures, or processor chip design. When information or instructions are provided via a network, or another communications connection (either hardwired, wireless, or combination thereof), to a machine, the machine properly views the connection as a machine-readable media. Thus, any such connection is properly termed a machine-readable media. Combinations of the above should also be comprised within the scope of the machine-readable storage devices.

Machine-executable instructions comprise, for example, instructions and data which cause a general-purpose machine, special purpose machine, or special purpose processing device to perform a certain function or group of functions. Machine-executable instructions also comprise program modules that are executed by machines in stand-alone or network environments. Generally, program modules comprise routines, programs, components, data structures, objects, and the functions inherent in the design of special-purpose processors, etc. that perform particular tasks or implement particular abstract data types. Machine-executable instructions, associated data structures, and program modules represent examples of the program code for executing steps of the methods disclosed herein. The particular sequence of such executable instructions or associated data structures represents examples of corresponding acts for implementing the functions described in such steps.

In additional examples, methods may be practiced in network computing environments with many types of machine system configurations, comprising processing machines, hand-held devices, multi-processor systems, microprocessor-based or programmable consumer electronics, network PCs, mini-machines, mainframe machines, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

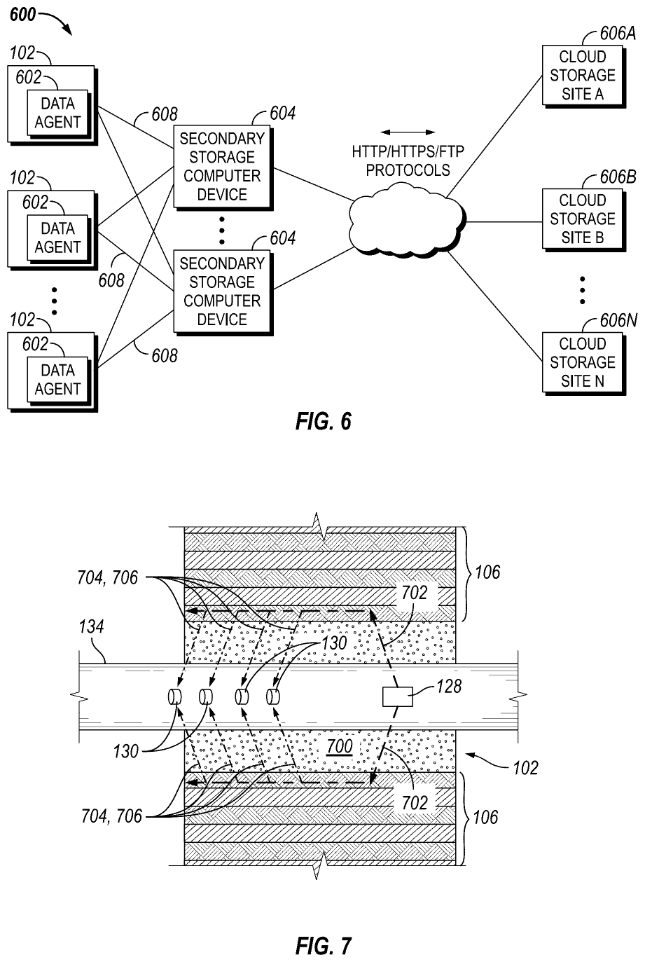

FIG. 6 illustrates an example of one arrangement of resources in a computing network 600 that may employ the processes and techniques described herein, although many others are of course possible. As noted above, an Information handling system 114, as part of their function, may utilize data, which comprises files, directories, metadata (e.g., access control list (ACLS) creation/edit dates associated with the data, etc.), and other data objects. The data on information handling system 114 is typically a primary copy (e.g., a production copy). During a copy, backup, archive or other storage operation, Information handling system 114 may send a copy of some data objects (or some components thereof) to a secondary storage computing device 604 by utilizing one or more data agents 602.

A data agent 602 may be a desktop application, website application, or any software-based application that is run on Information handling system 114. As illustrated, Information handling system 114 may be disposed at any rig site (e.g., referring to FIG. 1), off site location, or repair and manufacturing center. The data agent may communicate with a secondary storage computing device 604 using communication protocol 608 in a wired or wireless system. Communication protocol 608 may function and operate as an input to a website application. In the website application, field data related to pre- and post-operations, generated DTCs, notes, and the like may be uploaded. Additionally, Information handling system 114 may utilize communication protocol 608 to access, process, analyze, and/or compute acoustic waveforms that have been sensed, measured, and/or recorded by acoustic logging tool 102. This information is accessed from secondary storage computing device 604 by data agent 602, which is loaded on Information handling system 114.

Secondary storage computing device 604 may operate and function to create secondary copies of primary data objects (or some components thereof) in various cloud storage sites 606A-N. Additionally, secondary storage computing device 604 may run determinative algorithms on data uploaded from one or more information handling systems 114, discussed further below. Communications between the secondary storage computing devices 604 and cloud storage sites 606A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 606A-N, the secondary storage computing device 604 may also perform local content indexing and/or local object-level, sub-object-level or block-level deduplication when performing storage operations involving various cloud storage sites 606A-N. Cloud storage sites 606A-N may further record and maintain, acoustic waveforms that have been sensed, measured, and/or recorded by acoustic logging tool 102. Further cloud storage sites 606A-N may provide outputs from determinative algorithms utilizing the acoustic waveforms that are located in cloud storage sites 606A-N. In a non-limiting example, this type of network may be utilized as a platform to store, backup, analyze, import, preform extract, transform and load (“ETL”) processes, mathematically process, apply machine learning models, and augment acoustic measurement data sets. As disclosed herein, measurements obtained from downhole measurement operations, as discussed above, may be processed using computing network 600. For example, measurements from acoustic logging tool 102 may be processed using methods and systems described above to obtain a Horizontal Transverse Isotropy (HTI) of subterranean formation 132 (e.g., referring to FIG. 1).

FIG. 7 illustrates acoustic logging tool 102 disposed horizontally withing subterranean formation 132. FIG. 7 may be representative of acoustic logging tool 102 disposed within subterranean formation 132 by either drilling operation 100 or wireline operation 200. Acoustic logging tool 102 may utilize methods and systems described above to obtain an HTI of subterranean formation 132. An HTI may describe an anisotropy of subterranean formation 132 in a horizontal or vertical plane. For example, HTI may be found in a horizontal borehole 124 inside subterranean formation 132, where subterranean formation 132 may comprise horizontal geological beddings. In another example, HTI may be found in a vertical borehole 124 inside subterranean formation 132, where subterranean formation 132 may comprise vertical fractures. As illustrated, acoustic logging tool 102 may be disposed in a borehole 124, which may be filled with fluid 700. Fluid 700 may comprise drilling fluid, mud, and/or any other downhole fluids. Measurement methods to obtain an HTI of subterranean formation 132 may utilize an acoustic logging tool 102 comprising one or more transmitters 128 and/or one or more receivers 130. Additionally, as described above, one or more receivers 130 may be disposed on receiver station 202. In examples, one or more transmitters 128 may transmit acoustic waveforms 702 into borehole 124, and at least one acoustic waveform 702 may further travel into subterranean formation 132. As discussed in greater detail below, acoustic waveforms 702 that may be transmitted into subterranean formation 132 as shear waves. Acoustic waveforms 702 that travel into subterranean formation 132 may split into fast shear waveforms 704 and slow shear waveforms 706.

A fast shear waveform 704 is defined as acoustic waveforms 702 with particle motion along a fracture plane and slow shear waveforms 706 are defined as acoustic waveforms 702 with particle motion perpendicular to the fracture plane. As fast shear waveforms 704 and slow shear waveforms 706 propagate through subterranean formation 132, they may be sensed, measured, and/or recorded by one or more receivers 130. The general use of the system described above may allow for measurements to be made to form and HTI of a selected area within subterranean formation 132.

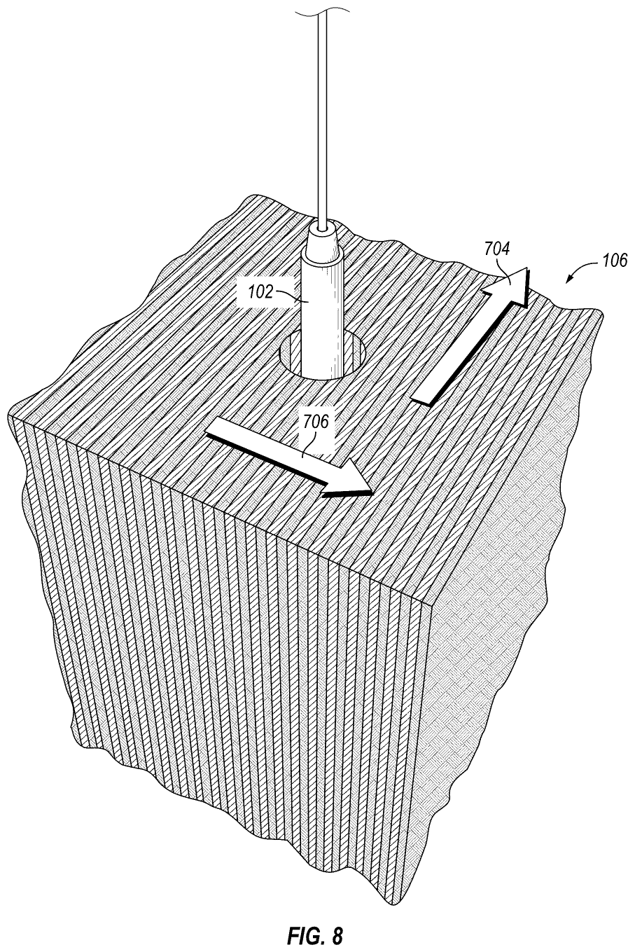

FIG. 8 illustrates acoustic logging tool 102 disposed vertically withing subterranean formation 132. As noted above, acoustic waveforms 702, for example shear waves, may enter an anisotropic medium, such as subterranean formation 132 illustrated in FIG. 8, may split into fast shear waveform 704 and slow shear waveform 706 while propagating. Fast shear waveforms 704 may travel within homogenous mediums within subterranean formation 132, as opposed to slow shear waveforms 706 that may travel perpendicular to a plurality of different types of mediums in subterranean formation 132. This is assuming subterranean formation 132 is the same medium with different mechanical properties in different directions. Fast shear waveforms 704 may travel faster than slow shear waveforms 706 in subterranean formation 132. Measurements of fast shear waveforms 704 and slow shear waveforms 706 may further be quantified as shear slowness values for fast shear waveform 704 and slow shear waveform 706. These values may be utilized to form an HTI measurement. The HTI measurement may provide information on properties of interest of subterranean formation 132, based at least in part on the shear slowness values.

HTI measurements may be processed using methods and systems, and the quality of data measured from acoustic logging tool 102 may depend on many factors. Assumptions in measurements may be made when processing velocity (e.g., referring to FIG. 7). For example, it may be assumed that borehole 124 may be sufficiently circular in shape from drilling operations (e.g., referring to FIG. 1). Additionally, it may be assumed that the interior surface of borehole 124 may be relatively smooth, which is to say borehole geometry may be assumed to be close to a theoretical cylinder, simplifying mathematical operations. It is not for practical reasons. Further, it may be assumed that borehole 124 may have a stable radius along the length of distance between transmitter 128 and receiver 130 disposed on acoustic logging tool 102. Moreover, it may be assumed that acoustic logging tool 102 may be centralized in borehole 124. Regarding the axis of acoustic logging tool 102, it may be assumed that the axis of acoustic logging tool 102 may lie within at least part of a bedding layer within subterranean formation 132. Additionally, it may be assumed that the formation axis of symmetry may be perpendicular to the axis of acoustic logging tool 102. During measurement operations, it may be assumed that measurements from acoustic logging tool 102 may not perform excessive rotation in azimuth while logging. In other words, if acoustic logging tool 102 rotates in azimuth excessively, measurements obtained may be inaccurate or skewed. Another assumption may be that the logging speed of acoustic logging tool 102 may be acceptable to maintain acoustic signal quality and keep the noise in the signals received to be minimal. In addition, it may be assumed that transmitters 128 may generate acoustic waveforms 702 in the same amplitude and same acoustic signal shape in both the X direction and Y direction, as transmitters 128 may be further identified as an X and Y source, depending on orientation. It may be assumed that receivers 130 disposed on acoustic logging tool 102 may be configured such that receivers 130 may pick up the same acoustic signal values if put under the same transmission pressure.

Under these assumptions, this may allow for an ideal measurement operation of HTI. Thus, the following relationships, formed from assumptions, may be assumed to be true and used to infer the value of measurements of fast shear waveform 704 and slow shear waveform 706 (e.g., referring to FIG. 7). For example, calculated shear slowness values may vary smoothly versus the azimuth angle. In the fast azimuth direction, shear slowness values may be at minimum. In the slow azimuth direction, shear slowness values may be at maximum. Fast azimuth and slow azimuth values may be 90 degrees apart. Shear velocity values, which may be the inverse of the shear slowness values, versus azimuth values may follow a constant plus cos(2θ) relationship. Crossline energy amplitude computed from acoustic waveforms 702 may vary smoothly versus azimuth angle. Additionally, if acoustic logging tool 102 is aligned with the fast azimuth or slow azimuth values, crossline energy may be at minimum.

However, different HTI algorithms rely on assumptions of different physical properties that exist in ideal conditions. Generally, HTI algorithms may try to solve for a solution against one of known HTI properties. As noted above, the use of each HTI algorithm may assume other properties of HTI would hold for this obtained solution. Sometimes, HTI algorithm may be used those other HTI properties as quality control metrics to check the correctness of the solution. During downhole measurement operations, described above, it is found that the assumptions listed earlier, mostly about the logging conditions, often do not hold. Further, because of the non-ideal logging environment, through studies of the cross-dipole logging waveforms, it is found that the HTI properties listed earlier often do not hold either. Thus, the practice of solving HTI against one HTI property and using other HTI properties as quality control is flawed.

The basic theory utilized within a large number of HTI algorithms is Alford Rotation. Although Alford Rotation is discussed below, any azimuth rotation or mathematical expression thereof may be utilized. Alford Rotation, while may be used in the systems and methods below, is merely a place holder for all forms of azimuth rotation. The HTI algorithms may be based on the geometric decomposition of waveforms twice, once at the source and the other time at the receiver, as expressed mathematically below.

$$XX = FP cos θ cos θ + SP sin θ sin θ \qquad ( 1 )$$

$$XY = SP sin θ cos θ - FP sin θ cos θ \qquad ( 2 )$$

$$YY = FP sin θ sin θ + SP cos θ cos θ \qquad ( 3 )$$

$$YX = - SP sin θ cos θ + FP sin θ cos θ \qquad ( 4 )$$

The value FP is a fast principal shear, and the value SP is the slow principal shear. θ is a fast angle, which is an angle measured between acoustic logging tool 102 azimuth reference and the fast direction of subterranean formation 132 (e.g., referring to FIG. 1). XX, XY, YX and YY are acoustic waveforms measured by acoustic logging tool 102. As defined herein, fast direction is defined as an angle between particle motion of fast shear waveform 704 and the angular reference of acoustic logging tool 102. Often in many algorithms, the Alford rotation equations are used reversely.

$$FP = XX cos θ cos θ + YY sin θ + sin θ + sin θ cos θ ( XY + YX ) \qquad ( 5 )$$

$$SP = YY cos θ cos θ + XX sin θ sin θ - sin θ cos θ ( XY + YX ) \qquad ( 6 )$$

$$0 = XY cos θ - YX sin θ sin θ - sin θ cos θ XX - YY ) \qquad ( 7 )$$

$$0 = YX cos θ cos θ - XY sin θ sin θ - sin θ cos θ ( XX - YY ) \qquad ( 8 )$$

Equations (5) and (6) may provide a method to invert for FP and SP using the measured waveforms XX, XY, YX, and YY at the receiver arrays, while also assuming the fast angle is a known value. The left side of Equations (7) and (8) above are defined as crossline terms. When the fast angle assumption is close to the actual value, the amplitude of crossline waveforms may be reduced to a minimum.

Additionally, there may be one or more HTI algorithms that share similar principles. These algorithms may employ a certain derivation of Alford Rotation equations, discussed above, with an assumed fast angle. The algorithms may define an objective function using the measured cross-dipole waveforms while projecting the waveforms along a designated direction, and then find a solution in the space of [θ, DTFast, DTSlow] by minimizing the objective function.

For example, by propagating all the FPⱼ, SPⱼ back and forth between each pair of receiver stations 202 (m, n) (e.g., referring to FIG. 2), using assumed [θ, DTFast, DTSlow], while assuming the propagated FPⱼ and SPⱼ have the same waveform signature, a minimization may be performed. The objective is to minimize the total residue of all propagated

$${( {FP}_{m , n} - {SP}_{m , n} )}^{2} + {( {FP}_{m , n}^{′} - {SP}_{m , n}^{′} )}^{2} .$$

Here m or n are the indexes of an arbitrary pair of receiver stations 202. The value, j, is the index of an arbitrary receiver station 202. In another example, propagating all the FPⱼ back to source using assumed [θ, DTFast], may allow for minimization. The objective is to minimize the deviation of the many back propagated FPⱼ from the source signature. In another example, the objective function may be changed, at least in part, into

$$4 {( {FP}_{m , n} - {SP}_{m , n} )}^{2} + {( {FP}_{m , n}^{′} - {SP}_{m , n}^{′} )}^{2} \qquad ( 9 )$$

As seen above, Equation (9) may simplify the derivation. This made the new objective function made analytical solutions of θ possible for each [θ, DTFast−DTSlow], thus a 3D minimization problem may be transformed into a 2D minimization problem.

Among the outputs of the HTI algorithms, discussed above, the most basic solution to a HTI algorithm is the fast angle, θ. Often, because the borehole environment is not optimal, the fast angle azimuth results from the HTI algorithms discussed above, demonstrates substantial jitter or noise between adjacent acquisitions. Also, the HTI algorithms above cannot distinguish fast angle and slow angle which may theoretically be about 90 degrees apart. To overcome the jitter and angle ambiguity, the above-mentioned HTI algorithms tried to solve the fast azimuth angle jointly θ together with slowness values from fast shear waveform 704 and/or slow shear waveform 706 (e.g., referring to FIG. 8). The additional variable to be solved jointly introduced additional unknowns into algorithms, which may utilize more prior information in order to be solved. Thus, these algorithms rely on additional assumptions from the waveforms, such as the shape of acoustic waveform 702 and its time derivative being conserved while propagating in borehole 124 between different receiver stations 202 (e.g., referring to FIG. 7). These assumptions of the waveforms put more stringent requirements on the quality of the dataset. For this reason, these algorithms often do not work well in many circumstances.

To summarize, in practical processing of real-world datasets using the HTI algorithms discussed above, may be several shortcomings. For example, fast azimuth result jumps between the two candidate solutions that are about 90 degrees apart, when comparing fast azimuth of adjacent depth acquisitions. Additionally, when using the fast angle to perform Alford Rotation, to determine the slowness values on a rotated waveforms, the tentative fast slowness result may not turn out to be the fastest, nor the slow slowness results to be the slowest when compared with DTXX or DTYY of the same acquisition. Further, time-domain HTI algorithms solve for fast slowness and slow slowness, but those two values suffer from dipole dispersion. They cannot be used directly without dispersion correction. Additionally, setting up a time window and waveform filter for these algorithms requires a thorough understanding of the HTI phenomenon, which may sometimes be subjective. Concerns in utilizing the HTI algorithms discussed above to obtain an HTI have led to workflows discussed below to overcome the shortcomings discussed above.

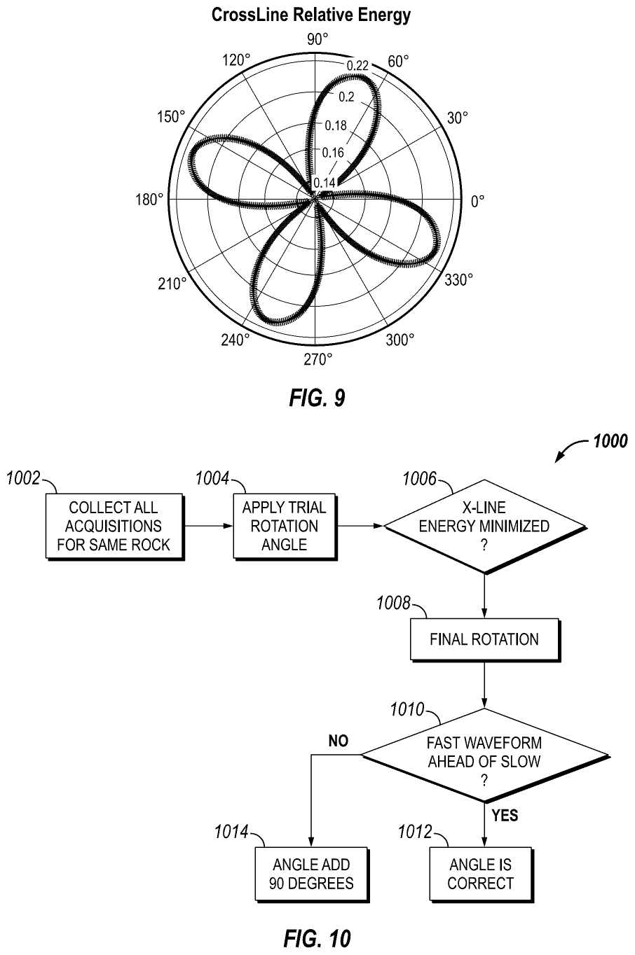

FIG. 10 illustrates workflow 1000 for performing a one-dimensional search, which may correct assumptions made in the HTI algorithms discussed above. It should be noted that at least a part of workflow 1000 may be performed on information handling system 114 (e.g., referring to FIG. 1). Workflow 1000 may project acoustic waveforms 702 (i.e., referring to FIG. 7), to trial fast angles by minimizing crossline energy to solve for fast angle values. As fast angle values are the only unknown in workflow 1000, discussed below, workflow 1000 may be a one-dimensional minimization problem. Compared with HTI algorithms discussed above, additional data may be employed from multiple acquisitions to solve for each fast azimuth, while HTI algorithms discussed above only used fast shear waveforms 704 and slow shear waveforms 706 from a single acquisition. The fast azimuth is defined as the direction in which fast shear waveforms 704 travel. In workflow 1000, additional information from multiple fast shear waveforms 704 and slow shear waveforms 706 being used to solve for fast azimuth may provide stable results. FIG. 9 is a graph of crossline relative energy. As illustrated, crossline energy vs trial fast angle using waveforms from multiple acquisitions. It can be seen that the amplitude of crossline energy is sensitive to the trial fast angle used in Alford Rotation.

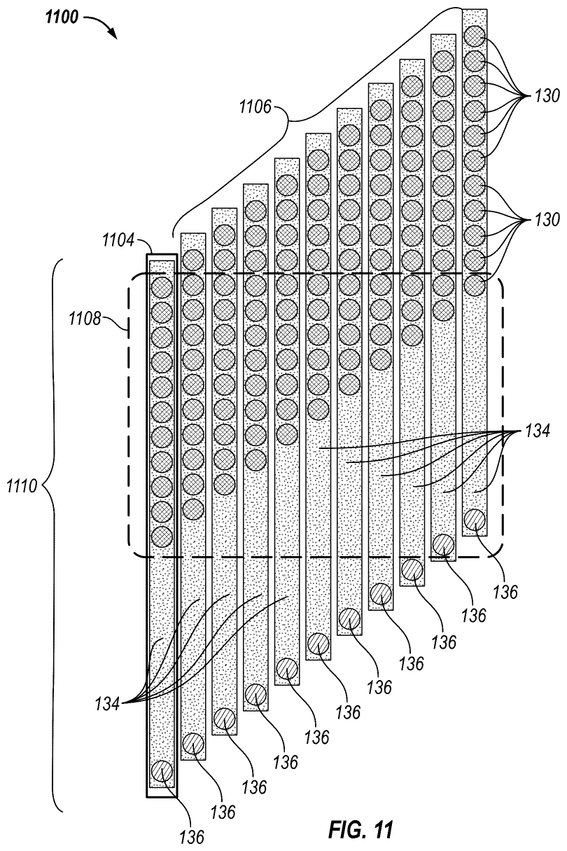

Workflow 1000 may begin with block 1002. In block 1002, one or more acquisitions may be performed. FIG. 11 illustrates a measurement operation 1100 utilizing acoustic logging tool 102, that comprises one or more transmitters 128 and/or one or more receivers 130, according to the methods and systems described above. As illustrated, during measurement operations 1100, one or more acquisitions may be acquired by one or more receivers 130, which may be disposed at one or more receiver stations 202. As illustrated, due to the nature of acoustic logging, there may be one or more acquisitions from which at least part of different receiver stations 202 may capture fast shear waveforms 704 and/or slow shear waveforms 706 at the same depth for multiple acquisitions. It is noted that a depth range 1110 of covers the distance between one or more transmitters 128 and the furthest receiver 130 or receiver station 202 disposed on acoustic logging tool 102.

As noted above, during measurement operations, shear waveforms (i.e., acoustic waveforms 702) may travel through subterranean formation 132 in depth range 1110. A first acquisition of fast shear waveform 704 and slow shear waveform 706, as illustrated may be known as the reference acquisition 1104. Reference acquisition 1104 may depict acoustic logging tool 102 with a set of support acquisitions 1106, which may be captured after reference acquisition 1104. Although support acquisitions 1106 are illustrated as moving in an upward direction within borehole 124, support acquisitions 1106 may allow be moving in a downward direction within borehole 124.

A shear wave, formed from one or more transmitters 128, which may comprise a dipole source or any other suitable source, may travel as discussed above to the last receiver station 202 and cover depth range 1110. The number of acquisitions may vary as depicted. In examples, if acoustic logging tool 102 is shifting 0.5 ft per acquisition, there may be ten or more support acquisitions 1106 with shear waveform travel path partially overlapping with the reference acquisition 1104. As illustrated, window 1108 illustrates a designated area in which fast shear waveforms 704 and/or slow shear waveforms 706 may be collected by multiple receiver stations at different support acquisitions 1106 and reference acquisition 1104. In this illustration, there are 66 receiver stations 202 support acquisitions 1106 and reference acquisition 1104 within window 1108. This may allow for six times more fast shear waveforms 704 and slow shear waveforms 706 measurements to feed into workflow 1000, as compared with only eleven receiver stations 202 measurements of fast shear waveforms 704 and/or slow shear waveforms 706 for a single acquisition. The sensed, measured, and recorded waveforms 706 from each measurement within window 1108 may be utilized as data for input in block 1004.

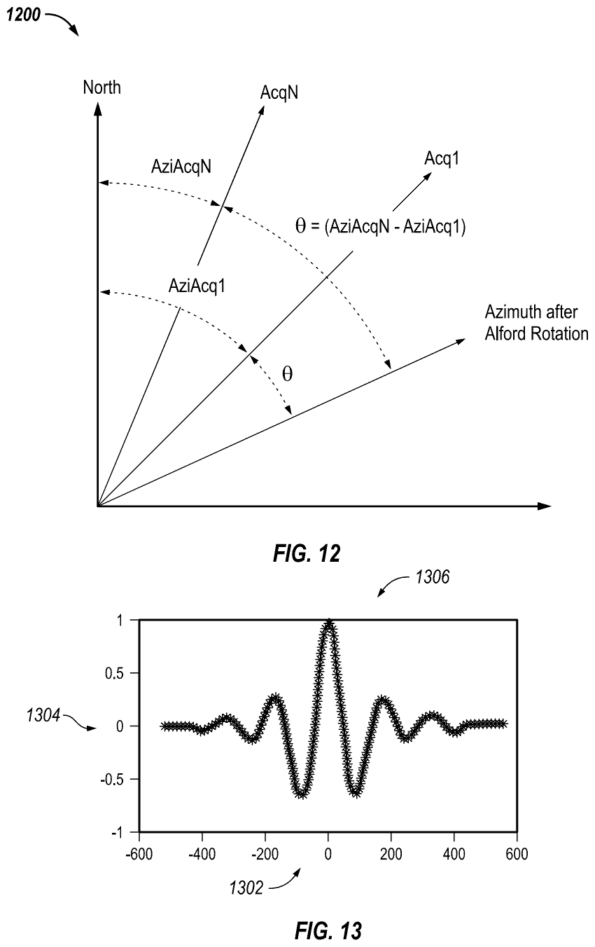

In block 1004, a trial rotation angle may be applied to the data from block 1002. Specifically, applying a trial angle selected from the one or more angles of the azimuth rotation angle array to project one or more acquired data collectively to one or more designated azimuths to calculate a fast shear waveform. During measurement operations, acoustic logging tool 102 may rotate between each support acquisitions 1106 and reference acquisition 1104 (e.g., referring to FIG. 11). FIG. 12 is a graph 1200 corresponding to different acquisitions and different rotation angles that may be applied for the rotated acoustic signal to be pointing at the same Alford Rotated Azimuth. Additionally, Table 1 corresponds to the illustration of FIG. 12. For reference acquisition 1104, the azimuth of acoustic logging tool 102 is at AziAcq1, while for supporting acquisition N, the azimuth of acoustic logging tool 102 is at AziAcqN.

TABLE 1

| Tool Orientation | Apply this Amount of Rotation | Points To |
|---|---|---|
| AziAcq1 | θ | θ + AziAcq1 |
| AziAcqN | θ − (AziAcqN − AziAcq1) | θ + AziAcq1 |

Using Equations (5)-(8), projecting acoustic waveforms may be performed. It should be noted that Equation (5) may solve for fast shear, Equation (6) may solve for slow shear, Equation (7) may solve for a first x-line energy, and Equation (8) may solve for a second x-line energy. The solved for values from Equations (5)-(8) may identify a rotation angle that may be utilized in block 1006.

In block 1006, for each acquisition, using acoustic signals from both the reference acquisition 1104 and supporting acquisitions 1106, fast angle θ may be solved for to minimize the crossline energy. As shown below, Equation (10) may illustrate minimization as a function of θ.

$$\frac{Sum ( Abs ( XLINE 1 ) ) + Sum ( Abs ( XLINE 2 ) )}{Sum ( Abs ( FP ) ) + Sum ( Abs ( SP ) )} \qquad ( 10 )$$

As workflow 1000 algorithm also may inherit 90-degree ambiguity problems from Alford Rotation algorithms, when a solution θ that minimizes the crossline energy is found in block 1006, an Alford Rotation may be performed on all the receiver stations 202 in block 1008. However, if a minimization is not found using Equation (10), workflow 1000 may restart at block 1004 and repeat until a minimization is found.

In block 1010, it may be determined if fast shear waveforms 704 is ahead of slow shear waveforms 706 that may be sensed, captured, and/or measured as described above in the systems and methods. For each receiver station 202 (e.g., referring to FIG. 11) in this example, fast shear waveforms 704 and slow shear waveforms 706 may be sensed, measured, and/or recorded according to the methods and systems described above. The fast acoustic waveform and a slow acoustic waveform may be cross correlated to determine whether the fast acoustic waveform is ahead of the slow acoustic signal. Referring back to FIG. 11, there may be sixty-six receiver stations 202, from which fast shear waveforms 704 and slow shear waveforms 706 may be sensed, measured, and/or recorded, from which this determination is based on. Instead of polling the fast/slow decision from one or more receiver stations 202, a stretch/squeeze method may be employed. Since related receiver stations 202 may have various transmitter-to-receiver distances, it may be assumed in this example that HTI properties between one or more transmitters 128 and receivers 130 may be similar. With this assumption, the time delay between fast and slow acoustic signals may be proportional to the transmitter-receiver distance. Thus, for each of the cross-correlate results, it may be squeezed/stretched in time according to its transmitter-receiver distance using the transmitter-to-first receiver distance as a reference. After this occurs, the stretched correlation arrays from one or more receiver stations 202 may be aligned to have the same time difference between fast and slow acoustic signals. Additionally, the arrays may be stacked together to make final determinations.

FIG. 13 illustrates a graph with the peak location in an x coordinate representing the time delay between fast acoustic signals and slow acoustic signals. In FIG. 13, x-coordinates 1302 represent the time difference between fast shear waveforms 704 and slow shear waveforms 706, y-coordinates 1304 represent the cross-correlation amplitude corresponding to the time difference. In this example, x-coordinate 1302 may be at its peak location 1306. If peak location 1306 has a positive index, fast waveform for θ may be slower than slow waveforms. Referring back to FIG. 10, in block 1014, to correct for this occurrence, fast angle values may be θ+90 degrees. Otherwise, in block 1012, θ may be the correct fast angle solution, completing workflow 1000.

During measurement operations, a measurement point of acoustic logging tool 102 (e.g., referring to FIG. 11) may be identified. A measurement point is a location on acoustic logging tool 102 that identifies a point in which a measurement value is obtained. A measurement value may represent the property of rock where the measurement point on acoustic logging tool 102 is disposed. Generally, for a time-domain HTI algorithm, if the HTI algorithm relies on acoustic signal timing or amplitude, measurement points may be at a location in the middle of acoustic logging tool 102, which may be disposed between one or more transmitters 128 and receiver station 202. This may be contrary to the belief that the measurement point may be disposed at the center of a receiver array that comprises a plurality of receiver stations 202 (e.g., referring to FIG. 2). It should be noted that the measurement point of an HTI algorithm depends on the type of physical measurement which may be imposed onto the HTI algorithm in real-world scenario, such as waveform amplitude, phase, frequency, arrival time, slowness etc.

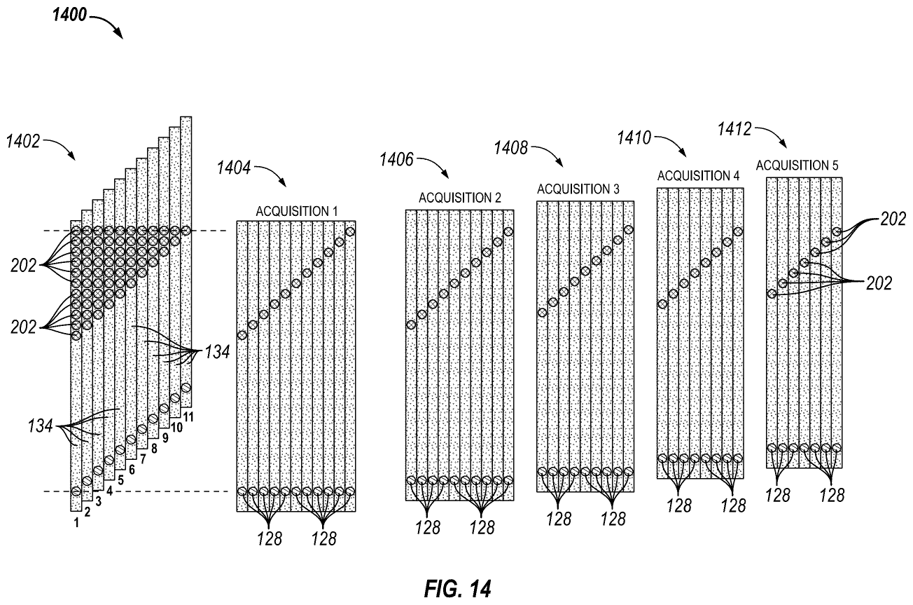

FIG. 14 illustrates the rock path between each transmitter and receiver pair for the main acquisition and part of supporting acquisition in an expanded view 1400. Without limitation, acoustic logging tool 102 may move at various rates, which may be dependent on measurement operation parameters. Acquisitions 1402, 1404, 1406, 1408, 1410, and 1412 are additional acquisitions that may be plotted with one or more transmitters 128, and one or more receiver stations 202 may be depicted in an expanded manner. While only five acquisitions arc illustrated, as noted above, there are a total of eleven acquisitions in the current example. However, there may be more acquisitions if acoustic logging tool 102 traverses in depth increments smaller than the distance between adjacent receiver stations 202.

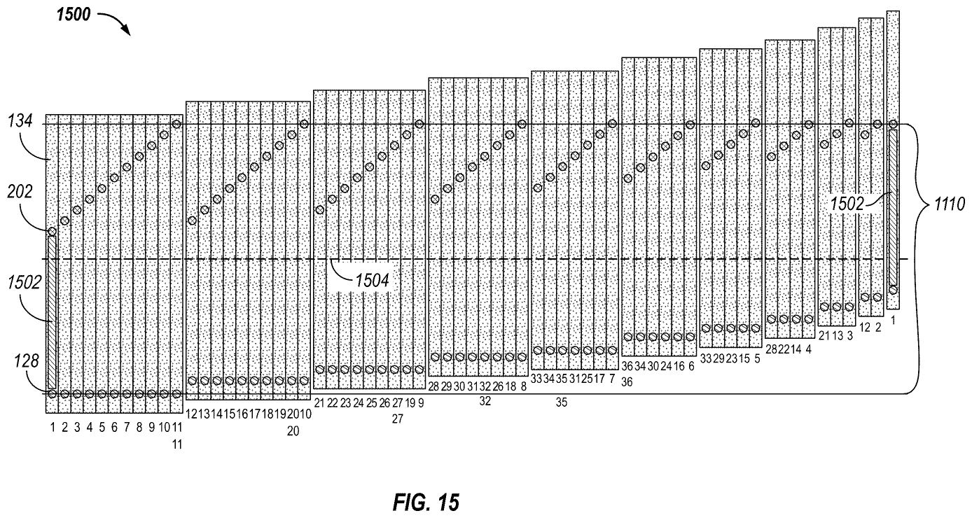

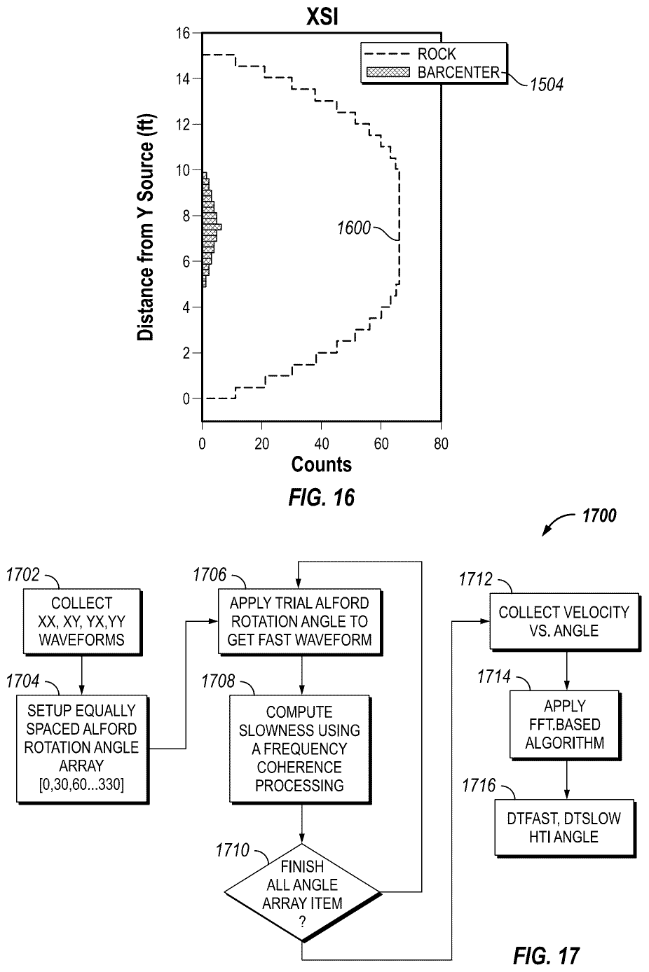

FIG. 15 illustrates acoustic paths 1502 between one or more transmitters 128 and receiver station 202, disposed on acoustic logging tool 102 in an expanded view 1500. At each receiver station 202, acoustic waveforms 702 contain accumulated effects from the path between one or more transmitters 128 and receivers 130, as described above in FIG. 16. In this illustration, two paths 1502 are plotted as vertical bars, and paths 1502 are symmetric with respect to the center point of one or more transmitters 128 and the last receiver station 202 of reference acquisition 1104. Further detailed study reveals that each of the sixty-six acoustic paths 1502 may come in as symmetric pairs. Each of the sixty-six acoustic paths 1502 may be numbered from 1 to 66, starting from left to right. The path number of its symmetric pair may be listed at the bottom of the plot for each path. FIG. 15 illustrates that rock formation properties that are processed using methods and systems to obtain an HTI within this depth range 1110 may not be drastically different, the sixty-six fast shear waveforms 704 and/or slow shear waveforms 706, which may be considered together, may show effects of complex rock paths.

With continued reference to FIG. 15, complex acoustic paths 1502 may be symmetric to a certain point of depth. For example, measurement point 1504 may be located at the mid-point between transmitter 128 and the eleventh receiver station 202, which may be the farthest from transmitter 128 and form depth range 1110. In other examples, measurement point 1504 may be 5 ft below the sixth receiver station 202, and in other examples, measurement point 1504 may be 4.875 ft above the fourth receiver station 202. Workflow 1000 may calculate measurement point 1504 dynamically when processing datasets that acoustic logging tool 102 moves not exactly 0.5 ft between acquisitions. If sixty-six acoustic paths 1502 are stacked together, acoustic paths 1502 may form a center-weighted profile, as shown in line 1600 of FIG. 16. Thus, the time-domain HTI algorithms may not have high resolution.

FIG. 16 is a graph that horizontally stacks each acoustic path 1502 in which an acoustic waveform may pass from transmitter 128 to receiver station 202 (e.g., referring to FIG. 15), as seen in FIG. 15. The horizontally stacked acoustic paths 1502 may from line 1600, which may be smoothed using a center-weighted window smoothing. As illustrated in the graph of FIG. 16, even with fast shear waveforms 704 and/or slow shear waveforms 706 measured from multiple acquisitions, fast angle results of workflow 1000 (e.g., referring to FIG. 10) may still show jitter between adjacent acquisitions. Additionally, circular statistical algorithms may be used to perform smoothing, which may take circular periodic nature into consideration. In examples, degree values 0 and 180 may essentially be the same direction of fast angles processed using methods and systems to obtain an HTI. Additional information may be used as pieces of information, and rock path profiles and HTI percentages may be used as weighting factors. The standard deviation of the fast angle values in this smoothing window may give the error estimation of the fast angle.

It should be noted that when implementing workflow 1000 (e.g., referring to FIG. 10) there may be a depth offset in the final values. This depth offset may provide logistic difficulty for logging application programming, which may expect the output to be on the same depth as the input. Thus, workflow 1000 may first process reference acquisition and all support acquisitions 1106 (e.g., referring to FIG. 11), as described above, to get the fast azimuth values in the earth coordinates with a depth offset. Additionally, while taking the orientation of acoustic logging tool 102 into consideration, a postprocessing step may be performed to recalculate fast angle results at the center of receiver station 202 (e.g., referring to FIG. 16) at each acquisition.

As noted above, if slowness measurement using the receiver array is applied, then the measurement point 1504 is still at the center of the receiver array. This may be due to velocity measurements being a local measurement on the differences of fast shear waveforms 704 and/or slow shear waveforms 706 between receiver stations 202 (e.g., referring to FIG. 7). As described in herein, shear velocity, of acoustic waveforms 702 and/or fast shear waveforms 704 and slow shear waveforms 706, may be modeled and analyzed using methods and systems used to obtain an HTI may be at any angle and may follow the below Equation (11) and Equation (12).

$${v}_{inline} ( θ ) = {v}_{fast} {cos}^{2} ( θ - {θ}_{fast} ) + {v}_{slow} {sin}^{2} ( θ - {θ}_{fast} ) \qquad ( 11 )$$

A simple transformation makes the above Equation (11) into Equation (12):

$${v}_{inline} ( θ ) = \frac{{v}_{fast} + {v}_{slow}}{2} + \frac{{v}_{fast} - {v}_{slow}}{2} cos 2 ( θ - {θ}_{fast} ) \qquad ( 12 )$$

Equation (11) may contain one constant plus another constant multiplied by a cos 2θ term. Additionally, constants in Equation (12) may be estimated from measurements of acoustic waveforms 702. As discussed above, Alford Rotation may not rely on every assumption and may be regarded as a fundamental equation in processing using methods and systems to obtain an HTI. With Alford Rotation, acoustic waveforms 702 obtained from acoustic logging tool 102 may be rotated to any angle of choice to obtain acoustic waveforms 702 that may be inline. Additionally, inline acoustic waveforms 702 at this angle may be processed by coherence processing to obtain shear velocity without the need for dispersion correction. Coherence processing is a processing method in which inputs are an array of waveforms received by an array of receivers generally equally spaced. A time shift or frequency shift may be applied to the array of waveforms to determine if resulting waveforms become more coherent or not. If they become more coherent, it means the trial shift is correct in detecting the slowness. Operating in the time domain, the output is a relationship between time and slowness. Operating in frequency domain, the output is a relationship between frequency and slowness. If the angle is varied in a regularly spaced manner, a relationship of inline shear velocity vs azimuth angle may be obtained for processing.

FIG. 17 illustrates workflow 1700 for velocity decomposition, which varies an angle in a regularly spaced manner to allow for a relationship of inline shear velocity vs azimuth angle to be obtained for additional processing. This is based on the Alford Rotation, discussed above. It should be noted that at least a part of workflow 1700 may be performed on information handling system 114 (e.g., referring to FIG. 1). Workflow 1700 may begin with block 1702. In block 1702 one or more acoustic waveforms in the XX, XY, YX, and YY direction may be sensed, measured, and/or recorded using the systems and methods described above. Within block 1702, referring to FIG. 11, for support acquisitions 1106 and reference acquisition 1104, all cross-dipole waveforms may be collected. In block 1704, an equally spaced Alford Rotation angle array spanning a full circle may be set up. For example, the Alford rotation angle array value may be 0, 30, 60 . . . 330. In block 1706, a trial Alford Rotation angle is applied to get a fast waveform for a first angle array value identified in block 1704. For each of the values in the angle array, an Alford Rotation may be performed to determine an inline acoustic signal. This processing is similar to the methods and systems discussed in blocks 1004-1008 (e.g., referring to FIG. 10), discussed above. Once a fast waveform value is found in block 1706, the value is sent to block 1708.

In block 1708, slowness values may be computed using coherence processing. As noted above, coherence processing may be performed in both time and frequency domain, thus, there may be a frequency coherence processing and time coherence processing. The input is fast shear waveforms 704 and slow shear waveforms 706 from array of receivers 130, the output is a result of slowness vs frequency. For acoustic logging tool 102, for slowness vs frequency relationship to the low end of frequency range, shear slowness of subterranean formation 132 may be found. Once the slowness value is found, in block 1710, blocks 1706-1708 are repeated until all rotation angles in the rotation angle array found in block 1704 have been processed. Once a determination is made comprising the completion of all angle arrays, inline acoustic signal may be processed using coherence processing to get the velocity. In block 1712 of workflow 1700, velocity vs. angle may be calculated. For example, using the process to move through Equations (1)-(12), an equally spaced angle array around 360 degrees may be found. For each angle in this array, a fast shear waveform 704 and a slow shear waveform 706 are found using each angle via Alford rotation. The output is an inline dipole waveform (i.e., XX and YY) for each angle. The inline dipole waveform using coherence processing may be processed to get a slowness value, each angle now corresponds to a slowness value (as described above). The equally spaced angle array now corresponds to a slowness array. Noting the velocity means 1/slowness, the velocity vs angle relationship, as described above. As described below, the angle array does not need to be equally spaced over 360 degrees. Being equally spaced may enable computation using Fast Fourier Transform (FFT), increasing computational speed. If not equally spaced, this may revert to a minimization problem, described above, which is slower.

From the velocity vs angle relationship, block 1714 of workflow 1700 may apply an FFT, a slow Fourier Transform, and/or a minimization that may invert the slowness values and fast angle values that are processed using methods and systems to obtain an HTI. For example, applying a transformation to frequency domain to model the velocity vs the angle relationship, such relationship refers to a bipolar beam shape relationship. As described in block 1714, the Fourier transform may be applied on the velocity array vᵢₙₗᵢₙₑ to get a transformed complex array VF. The absolute value of the first term of VF may be the constant term represented mathematically as:

$$\frac{{v}_{fast} + {v}_{slow}}{2} \qquad ( 13 )$$

while the absolute value of the third term of VF may be the constant term represented mathematically as:

$$\frac{{v}_{fast} + {v}_{slow}}{2} \qquad ( 14 )$$

in the inline velocity equation. The phase angle of the third term of VF may provide the fast angle θ_{fast}. From there, the v_{fast} and v_{slow} may be obtained and translated to slowness DTFast and DTSlow. As such, block 1716 may calculate the resulting calculations for DTfast, DTslow, and an HTI angle may be obtained, which may be used for processing using methods and systems described above to obtain an HTI.

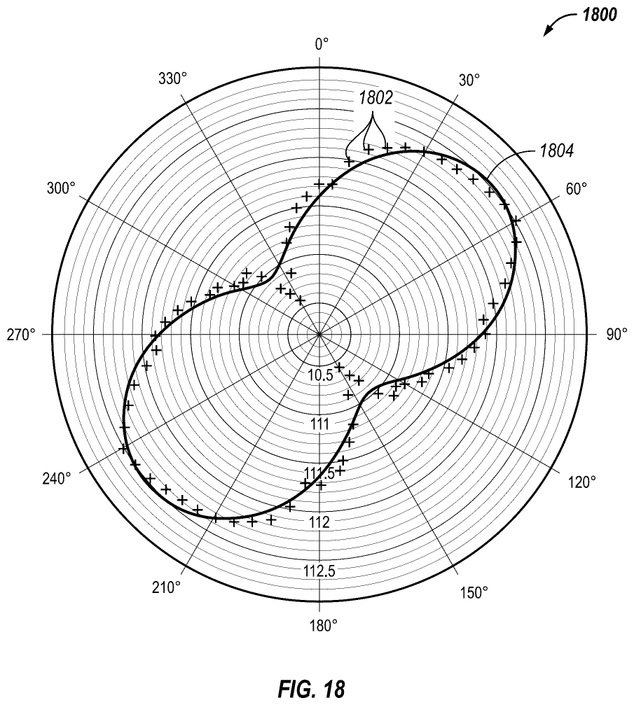

FIG. 18 is a graph plotting slowness vs. earth coordinates using workflow 1700 (e.g., referring to FIG. 17). Dataset 1800, which may be obtained in part from acoustic logging tool 102 (e.g., referring to FIG. 1), with relatively good signal quality. The radius of this plot is slowness in us/ft. In embodiments, crosses 1802 may represent the slowness values vs azimuth angle relationship obtained by the Alford Rotation and coherence processing. In such examples, solid line 1804 may additionally represent an example of the data to the theoretical relationship that may be obtained in block 1714 of workflow 1700. In embodiments, the radius of the plot, which may not be scaled to proper size, may be slowness as opposed to velocity. Additionally, at the center of the plot, slowness may not be at zero, and for this example, slowness may be at 110 us/ft.

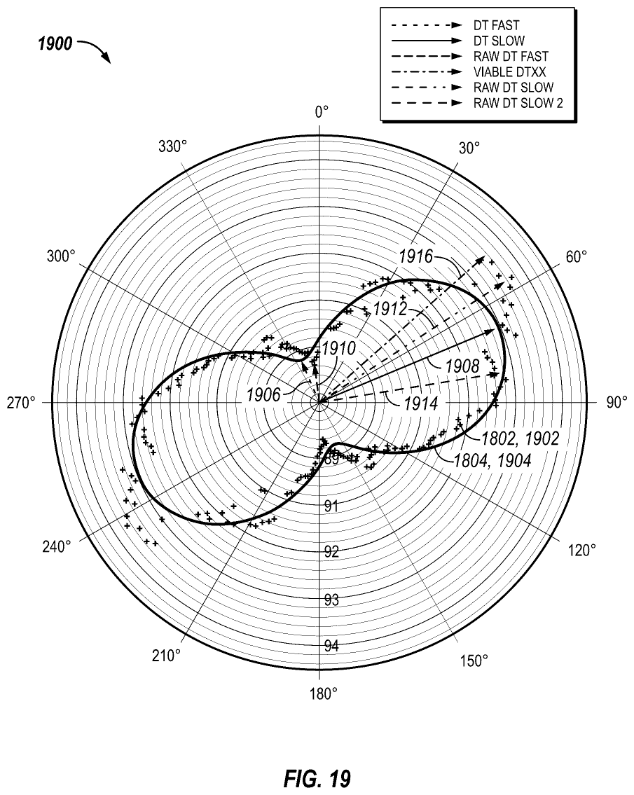

FIG. 19 is a graph plotting slowness vs. earth coordinates that shows inconsistent results utilizing current technology systems and methods. Specifically, FIG. 19 illustrates dataset 1900, which may be obtained in part from acoustic logging tool 102 (e.g., referring to FIG. 1), with relatively poor signal quality. The slowness vs. angle relationship measured from actual data, represented by crosses 1902, may not overlap with the theoretical relationship, represented by the line 1904, which may be an example of the slowness vs. angle data to the theoretical model processed using methods and systems to obtain an HTI. As discussed above, a successful HTI inversion may rely on environmental and operational assumptions. One or more of those assumptions may have deviated from situations when the acoustic waveforms 702 (e.g., referring to FIG. 7) were logged. Combined effects of deviations cause actual data not to follow the theoretical model processed using methods and systems to obtain an HTI. For this reason, the plot in FIG. 19 may serve as a comprehensive quality control presentation and may show how close the overall situation, comprising both the formation under study and data acquisition quality, may be a model processed using methods and systems to obtain an HTI.

As further illustrated in FIG. 19, errors may exist between crosses 1902 and line 1904, line 1904 being the theoretical output. The RMS of these error values for a particular acquisition may be used to estimate the uncertainty of the slowness of fast shear waveforms 704 (DTFast) and the slowness of slow shear waveforms 706 (DTSlow) measurement and the uncertainty of the HTI percentage, as illustrated in Equation (15) and Equation (16).

$$Slowness Uncertainty = RMS ( fitting error ) \qquad ( 15 )$$

$$HTI Uncertainty = \frac{Slowness Uncertainty * 2}{DTFast + DTSlow} \qquad ( 16 )$$

FIG. 19 could also be used to explain results in workflow 1700 at certain acquisitions that may not be consistent with the theoretical model processed using methods and systems to obtain an HTI, which may be an issue. In FIG. 19, DTFast 1906 and DTSlow 1908 are shown as vectors. The directions and length of the vectors may represent the fast/slow azimuth and may correspond to slowness values of DTFast 1906 and DTSlow 1908. In embodiments, these values may be obtained by workflow 1700 (e.g., referring to FIG. 17), which may make an example fit out of the HTI theoretical velocity vs angle relationship. On the contrary, any other time domain HTI algorithm, even with the measurement point corrected and dipole dispersion corrected, or any other local optimization algorithm, may find Raw DTFast 1910 or Raw DTSlow 1912, represented by vectors in the graph. In embodiments, these values may be the raw fastest point and raw slowest point in this slowness vs angle relationship. The slowness vs angle relationship may be mathematically expressed as:

$$A + B * cos ( 2 θ - C ) \qquad ( 17 )$$

Additionally, the angle between Raw DTFast 1910 and Raw DTSlow 1912 may not be 90 degrees apart in this case. Along with this reasoning, an algorithm may have first found Raw DTFast 1910 and then added 90 degrees to the fast angle and further processed the rotated acoustic signal to get a slow slowness. This slow slowness may be represented as Raw DTSlow2 1914, dashed vector 1914 in the illustration. The value of Raw DTSlow2 1914 may be faster than the Raw DTSlow 1912 in this case. Additionally, if the X receiver or Y receiver happens to be pointing to a direction close to Raw DTSlow 1912, for example, it may follow that there may be an alert to the fact that the Raw DTSlow2 1914 result may not be slower than Viable DTXX 1916, represented as a vector.

To summarize, in real-world acoustic logging practice, when the HTI model assumptions are violated, the various HTI model properties cannot be held all true. When designing or choosing an HTI algorithm, a compromise must be made to keep most of the HTI model properties intact. Workflow 1700 (e.g., referring to FIG. 17) applied a holistic methodology to invert HTI measurements from non-perfect data. During this process, the velocity decomposition plot may explain the remaining inconsistencies of the data from the ideal HTI model.

As discussed above, HTI processing discusses both workflow 1000 (e.g., referring to FIG. 10) and workflow 1700 (e.g., referring to FIG. 17). Workflow 1000 may only provide answers of fast angles. It provides two sets of answers. One set may be raw results from the crossline energy minimization. Another set may be a circularly smoothed result using a center-weighted window, as discussed above. From data processing experience, it may be found that under limited circumstances, the raw fast angle result may still suffer from 90-degree jumps due to signal quality issues. To correct this, workflow 1700 may be utilized regarding the theoretical relationship between slowness and angle. Workflow 1700 may not suffer from this 90-degree ambiguity. Thus, in the HTI processing application, the circularly smoothed version of the fast angle from workflow 1700 may have been used as a reference to correct the 90-degree ambiguity problem in workflow 1000 fast angle results.

In the current HTI processing application, workflow 1700 may also provide fast angle results as two sets of values, one set of direct results, and another set as circularly smoothed using the same central weighted window as workflow 1000. In this disclosure, fast slowness and slow slowness values and HTI percentage may come from workflow 1700.

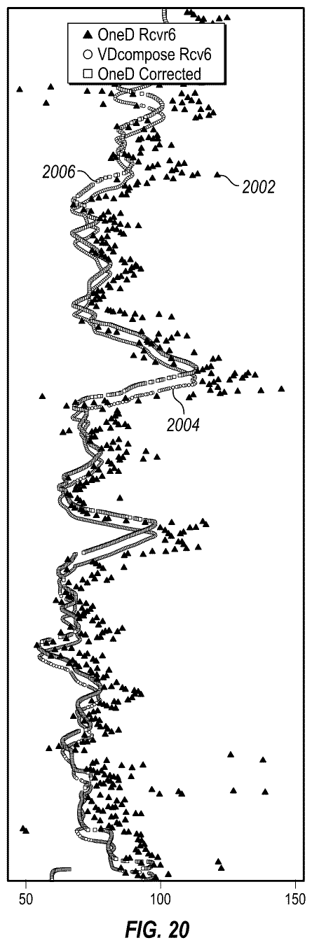

Further, one part of workflow 1700 may be coherence processing. For this reason, a feature may be that measurement point 1504 (e.g., referring to FIG. 15) for workflow 1700 may be at the center of the HTI receiver station 202. With continued reference to FIG. 15, in acoustic logging tool 102, this may be the sixth receiver station 202. As previously described, workflow 1000 has a measurement point about 5 ft below the sixth receiver station 202. FIG. 20 is a graph that shows differences in measurement points 1504 (e.g., referring to FIG. 15). For example, results 2002 may be the raw azimuth results from workflow 1000, which may result without considering the measurement point difference. Results 2004 may be the azimuth results from workflow 1700, which may be on depth. There may be a depth shift between the results of 2002 and the results of 2004. Dots 2006 may be workflow 1000 resulting after considering difference in measurement points 1504. It may match the results of 2004. The fact that both workflow 1000 and workflow 1700 with very different approaches may reach similar answers may give high confidence to the fast-angle answer.

Improvements over current technology regarding workflow 1000 may comprise providing fast azimuth answer not at the center of a receiver array, but at a measurement point of acoustic logging tool 102 (e.g., referring to FIGS. 1 & 2). This is not realized by other current HTI algorithms. Additionally, workflow 1000 may allow for measurement point correction on the azimuth result back to the center of receiver array.

Workflow 1700 further does not suffer from a 90-degree ambiguity which is in all of the time domain algorithms. Additionally, workflow 1700 algorithm is an improvement over current technology in that workflow 1700 is using a holistic fitting method to obtain the three main HTI answers, fast angle, DTFast, and DTSlow together. Current technology normally tries to use one of the HTI properties to get one answer, then use other HTI properties to compute the other two. In non-ideal dataset, which is how these three answers become contradictory to each other. The holistic method solving them together solves the biggest contradiction problem.

The preceding description provides various examples of the systems and methods of use disclosed herein which may contain different method steps and alternative combinations of components.
Statement 1: A method comprising disposing an acoustic logging tool in a borehole. The acoustic logging tool comprises one or more transmitters and one or more receivers. The method may further comprise taking one or more acquisitions with the acoustic logging tool as the acoustic logging tool traverses through the borehole, creating an azimuth rotation angle array of one or more angles, from the one or more acquisitions, and applying a trial angle selected from the one or more angles of the azimuth rotation angle array to calculate a fast shear waveform.
Statement 2: The method of statement 1, further comprising computing a slowness of the fast shear waveform using a coherence processing for each angle of the azimuth rotation angle array.
Statement 3: The method of statement 2, further comprising identifying a velocity vs angle for the fast shear waveform.
Statement 4: The method of statement 3, further comprising identifying a slow shear waveform from the angle.
Statement 5: The method of statement 4, further comprising finding an inline dipole from the slow shear waveform and the fast shear waveform.
Statement 6: The method of statement 5, further comprising finding a slowness value from the inline dipole using a coherence processing.
Statement 7: The method of statement 3, further comprising applying a transformation to frequency domain to model the velocity vs an angle relationship.
Statement 8: The method of statement 7, further comprising determining a DTfast, a DTslow, and a Horizontal Transverse Isotropy (HTI) angle from the frequency domain.
Statement 9: The method of any previous statements 1 or 2, wherein the one or more acquisitions comprise one or more XX, XY, YX, or YY acoustic waveforms.
Statement 10: The method of any previous statements 1, 2, or 9, wherein the azimuth rotation angle array is equally spaced.
Statement 11: A non-transitory machine-readable media having data stored therein representing a software executable by a computer, the software executable comprising instructions configured to set up an azimuth rotation angle array from one or more acquisitions taken by an acoustic logging tool and apply a trial rotation angle to an angle of the azimuth rotation angle array to calculate a fast shear waveform.
Statement 12: The non-transitory machine-readable media of statement 11, further comprising computing a slowness of the fast shear waveform using a coherence processing.
Statement 13: The non-transitory machine-readable media of statement 12, further comprising identifying a velocity vs angle for the fast shear waveform.
Statement 14: The non-transitory machine-readable media of statement 13, further comprising identifying a slow shear waveform from the angle.
Statement 15: The non-transitory machine-readable media of statement 14, further comprising finding an inline dipole from the slow shear waveform and the fast shear waveform.
Statement 16: The non-transitory machine-readable media of statement 15, further comprising finding a slowness value from the inline dipole using a coherence processing.
Statement 17: The non-transitory machine-readable media of statement 13, further comprising applying a Fast Fourier Transform (FFT) to the fast shear waveform.
Statement 18: The non-transitory machine-readable media of claim 17, further comprising determining a DTfast, a DTslow, and a Horizontal Transverse Isotropy (HTI) angle from a frequency domain.
Statement 19: The non-transitory machine-readable media of any previous statements 11 or 12, wherein the one or more acquisitions comprise one or more XX, XY, YX, or YY acoustic waveforms.
Statement 20: The non-transitory machine-readable media of any previous statements 11, 12 or 19, wherein the azimuth rotation angle array is equally spaced.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any comprised range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
disposing an acoustic logging tool in a borehole, wherein the acoustic logging tool comprises:
one or more transmitters; and
one or more receivers;
taking one or more acquisitions with the acoustic logging tool as the acoustic logging tool traverses through the borehole;
creating an azimuth rotation angle array of one or more angles, from the one or more acquisitions; and
applying a trial angle selected from the one or more angles of the azimuth rotation angle array to calculate a fast shear waveform.

2. The method of claim 1, further comprising computing a slowness of the fast shear waveform using a coherence processing for each angle of the azimuth rotation angle array.

3. The method of claim 2, further comprising identifying a velocity vs angle for the fast shear waveform.

4. The method of claim 3, further comprising identifying a slow shear waveform from the angle.

5. The method of claim 4, further comprising finding an inline dipole from the slow shear waveform and the fast shear waveform.

6. The method of claim 5, further comprising finding a slowness value from the inline dipole using a coherence processing.

7. The method of claim 3, further comprising applying a transformation to frequency domain to model the velocity vs an angle relationship.

8. The method of claim 7, further comprising determining a DTfast, a DTslow, and a Horizontal Transverse Isotropy (HTI) angle from the frequency domain.

9. The method of claim 1, wherein the one or more acquisitions comprise one or more XX, XY, YX, or YY acoustic waveforms.

10. The method of claim 1, wherein the azimuth rotation angle array is equally spaced.

11. A non-transitory machine-readable media having data stored therein representing a software executable by a computer, the software executable comprising instructions configured to:
set up an azimuth rotation angle array from one or more acquisitions taken by an acoustic logging tool; and
apply a trial rotation angle to an angle of the azimuth rotation angle array to calculate a fast shear waveform.

12. The non-transitory machine-readable media of claim 11, further comprising computing a slowness of the fast shear waveform using a coherence processing.

13. The non-transitory machine-readable media of claim 12, further comprising identifying a velocity vs angle for the fast shear waveform.

14. The non-transitory machine-readable media of claim 13, further comprising identifying a slow shear waveform from the angle.

15. The non-transitory machine-readable media of claim 14, further comprising finding an inline dipole from the slow shear waveform and the fast shear waveform.

16. The non-transitory machine-readable media of claim 15, further comprising finding a slowness value from the inline dipole using a coherence processing.

17. The non-transitory machine-readable media of claim 13, further comprising applying a Fast Fourier Transform (FFT) to the fast shear waveform.

18. The non-transitory machine-readable media of claim 17, further comprising determining a DTfast, a DTslow, and a Horizontal Transverse Isotropy (HTI) angle from a frequency domain.

19. The non-transitory machine-readable media of claim 11, wherein the one or more acquisitions comprise one or more XX, XY, YX, or YY acoustic waveforms.

20. The non-transitory machine-readable media of claim 11, wherein the azimuth rotation angle array is equally spaced.
